(19) United States
(12) Patent Application Publication
(10) Pub. No.: US 2008/0082654 A1
(43) Pub. Date: Apr. 3, 2008

(54) INTERROGATING CONTROLLERS FOR ALARMS AND EVENTS

(75) Inventors: Kevin Tambascio, Lyndhurst, OH (US); Eric G. Dorgelo, Port Moody (CA); John J. Baier, Mentor, OH (US); Kenwood H. Hall, Hudson, OH (US); David K. Johnson, Waukesha, WI (US); Dale Sapach, Roberts Creek (CA); Jan Bezdicek, Prelouc (CZ)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/537,438

(22) Filed: Sep. 29, 2006

(51) Int. Cl. G06F 15/177; G06F 15/173

(52) U.S. Cl. 709/224; 709/220

(57) ABSTRACT

A system that facilitates automatic discovery of alarms/events in an industrial environment comprises an analyzer component that receives a subscription to an alarm/event and analyzes the subscription. An interrogator component interrogates a field device to determine whether the field device generates alarms/events that conform to the subscription.

### TECHNICAL FIELD

The claimed subject matter relates generally to alarms and events within an industrial setting, and, more particularly, relates to automatically discovering alarms and events.

### BACKGROUND

Due to advances in computing technology, businesses today are able to operate more efficiently when compared to substantially similar businesses only a few years ago. For example, high speed data networks enable employees of a company to communicate instantaneously by email, quickly transfer data files to disparate employees, manipulate data files, share data relevant to a project to reduce duplications in work product, etc. Furthermore, advancements in technology have enabled factory applications to become partially or completely automated. For instance, activities that once required workers to put themselves proximate to heavy machinery and other various hazardous conditions can now be completed at a safe distance therefrom.

Further, imperfections associated with human action have been minimized through employment of highly precise machines. Many of these factory devices supply data related to manufacturing to databases (or web services referencing databases) that are accessible by system/process/project managers on a factory floor. For example, sensors and associated software can detect a number of instances that a particular machine has completed an operation given a defined amount of time. Further, data from sensors can be delivered to a processing unit related to system alarms. Thus, a factory automation system can review collected data and automatically and/or semi-automatically schedule maintenance of a device, replacement of a device, and other various procedures that relate to automating a process.

In typical control applications, alarms are generated when a process variable value lies outside a predefined expected range, when a sensed parameter lies outside an expected range, when particular user action is undertaken (such as depression of an emergency stop), and the like. These alarms provide an indication to an operator or device that an unexpected event has occurred with respect to a particular control process. In another example, alarms that are not associated with a high level of urgency can be created and logged, and may not be provided to an operator unless a more urgent, related alarm occurs. Thereafter, logs can be parsed in an effort to determine a source of failure with respect to a control process.

Conventionally, field devices produce or consume data and are monitored by a higher-level system, such as a Manufacturing Execution System (MES). These higher-level systems analyze data being produced and/or consumed on a factory floor and generate alarms if monitored data lies outside a predefined range. These alarms are typically created through use of static rules, which often do not account for the dynamic nature of a manufacturing process. Additionally, subscribing to alarms or events can be a time-consuming and/or complicated task. For example, conventionally, a software system that manages alarm includes a static list of devices/operators that subscribe to particular alarms. When new devices are added to a control environment, such devices must be configured (for alarm generation and/or receipt). Often, information technology (IT) specialists are required to perform the configuration, resulting in lost man-hours and increased costs in an industrial environment.

### SUMMARY

The following presents a simplified summary of subject matter described in more detail herein in order to provide a basic understanding of some aspects of such subject matter. This summary is not an extensive overview, and is not intended to identify key/critical elements or to delineate the scope of the subject matter described herein. Its sole purpose is to present some concepts in a simplified form as a prelude to the more detailed description that is presented later.

Briefly described, the subject disclosure pertains to automatically discovering alarms and events of particular types, subtypes, and/or the like within an industrial automation environment. Additionally, the disclosure pertains to automatically configuring field devices to publish certain alarms and/or events within an industrial automation environment. More specifically, alarms and/or events can be automatically discovered within an industrial automation environment by interrogating one or more field devices based upon an analysis of a subscription to alarms and/or events. For instance, an entity that desires to receive alarm instances of a particular type can be associated with a subscription to such an alarm type. Field devices that can generate alarms and/or events can be interrogated for alarms of such type. If a field device includes an alarm of the desired type, such alarm can be provided to the subscribing entity. Additionally, the field device can be configured to provide all alarms of such type generated within the field device (in the future) to the subscribing entity. A similar process can occur with respect to desired events. Thus, alarms and/or events of a desired type can be automatically subscribed to, and field devices that generate such alarms and/or events can be configured to automatically publish the alarms and/or events to subscribing entities.

As alluded to above, alarms and/or events can be associated with a certain type, subtype, can be assigned an identifier (such as a unique identifier or an identifier that identifies a collection of alarms/events), and other suitable parameters. In an example, alarms generated by field devices within a particular region can be associated with a substantially similar type. If a subscribing entity desires to receive alarms/events of such type, then multiple field devices (such as controllers) can publish alarms/events of that type and can be provided to the subscribing entity.

Moreover, a field device can be configured to provide alarms of particular types to subscribing entities upon the field device being initially coupled to an industrial network. In an example, a determination can be made that an industrial controller has been placed within a rack and coupled to a backplane. The controller can be interrogated to determine types of alarms and/or events that are capable of being generated by the controller. Based upon such information and subscription information (relating to subscribing entities), the industrial controller can be automatically configured to provide alarms/events of certain types, subtypes, and/or the like to certain subscribing entities.

To the accomplishment of the foregoing and related ends, certain illustrative aspects are described herein in connection with the following description and the annexed drawings. These aspects are indicative, however, of but a few of the various ways in which the principles of the invention can be employed and such subject matter is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates an example system that facilitates automatically discovering alarms/events within an industrial automation environment.

FIG. 2 illustrates an example field device configuration system.

FIG. 3 illustrates an example system that facilitates automatic provision of alarms/events to subscribing entities.

FIG. 4 illustrates an example field device that can create alarms and/or events.

FIG. 5 illustrates an example system that facilitates subscribing to alarms and/or events generated by a field device.

FIG. 6 illustrates an example event configuration.

FIG. 7 is a representative flow diagram illustrating an example methodology for configuring a field device with respect to publishing alarms and/or events.

FIG. 8 is a representative flow diagram illustrating an example methodology for automatically discovering alarms and/or events generated by field devices.

FIG. 9 is a representative flow diagram illustrating an example methodology for configuring a field device to provide certain alarms and/or events to subscribing entities.

FIG. 10 is an example computing environment.

FIG. 11 is an example networking environment.

### DETAILED DESCRIPTION

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that such matter can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component may be, but is not limited to a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

Furthermore, aspects of the disclosed subject matter may be implemented as a method, apparatus, or article of manufacture using standard programming and/or engineering techniques to produce software, firmware, hardware, or any combination thereof to control a computer to implement various aspects of the subject invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of what is described herein.

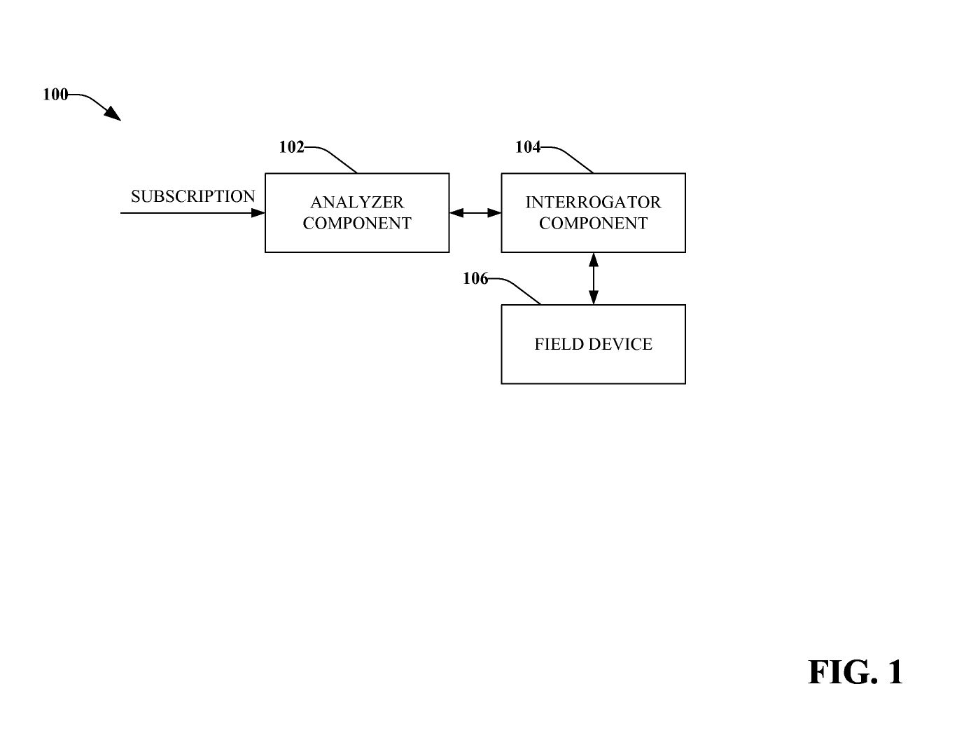

Now referring to the drawings, FIG. 1 illustrates a system 100 that facilitates automatic discovery of alarms/events generated by field devices within an industrial environment. The system 100 includes an analyzer component 102 that receives a subscription to an alarm or event and analyzes such subscription. More particularly, the received subscription can be associated with a particular type, such that a particular alarm or event is an instance of the type. Alarm types can be related to particular devices from which alarms originate and/or with which alarms are associated. Additionally, alarm types can relate to particular zones within a factory, certain operators, products, and/or the like. Moreover, events can be associated with a certain type, which can relate to devices, regions within an industrial facility, processes, individuals (such as operators), etc. Further, alarms and/or events can be of a user-defined type. Thus, alarms and/or events generated within an industrial environment can be of a certain type, and can therefore be instances of such type.

The subscription received by the analyzer component 102 can be a subscription for an alarm and/or event of a particular type. In other words, an entity that is associated with the subscription may desirably receive alarms and/or events of the certain type. Still further, certain alarms and/or events can be associated with identifiers (which may be unique identifiers), and the subscription can be for alarms associated with the identifier. Therefore, any alarm and/or event of a particular type and/or associated with a certain identifier can be desirably received by an entity subscribing to the alarm and/or event.

The analyzer component 102 can analyze the subscription and determine a type of an alarm or event associated with the subscription and/or a unique identifier related to the alarm and/or event, and can pass results of such analysis to an interrogator component 104. Accordingly, the interrogator component 104 can have knowledge of a type of alarm/event and/or a unique identifier of an alarm/event that is associated with the subscription received by the analyzer component 102. The interrogator component 104 can interrogate a field device 106 that generates alarms/events and/or publishes alarms/events for an alarm or event that is associated with an alarm/event type or unique identifier related to the subscription.

Thus, the field device 106 can generate alarms and/or log events, wherein such alarms/events can be of a particular type and/or associated with a certain identifier. For example, if the field device 106 is a logic controller within a certain region of an industrial manufacturing facility, an alarm generated by the field device 106 can be of a type that is associated with the region. The field device 106 can publish such alarm, retain the alarm within a data repository within the field device 106, and/or provide the alarm to a data repository that is external to the field device. The interrogator component 104 can interrogate the field device 106 for alarms/events of the particular type, and the field device 106 can then provide such alarms/events to the entity that is subscribing to the alarms/events. In another example, the interrogator component 104 can interrogate the field device to determine which alarm types can be created by the field device 106, and can automatically configure the field device 106 to provide alarms of a certain type to the subscribing entity.

In an example, a device may subscribe to alarms and/or events associated with a particular zone, wherein such alarms and/or events are designated as a particular type. When the field device 106 is added to such zone, the interrogator component can interrogate the field device 106 to determine which type of alarms and/or events can be created/published by the field device 106. If the field device 106 can generate alarms of type (or identifier) identified within the subscription, the field device 106 can be automatically configured to publish alarms of such type to a certain location or directly to the subscribing entity.

In yet another aspect, a graphical user interface can be provided that enables a user to view contents of the field device 106. For instance, a user can select a folder or icon that is representative of the field device 106, and contents thereof can be displayed. More particularly, the interrogator component 104 can interrogate the field device 106 to provide alarms/events within the field device and/or alarm/event generation capabilities associated with the field device 106. The user can then select an alarm/event from within the field device 106 and provide instructions relating to configuring the field device 106 to provide alarms/events of particular type to a subscribing entity. Thus, field devices, including controllers (e.g., logic controllers, robotic controllers, . . . ), pumps, presses, and/or other field devices, can be automatically interrogated to determine alarms/events associated therewith. Given the above, it can be discerned that a user need not configure a subscription to an alarm/event, but can instead select a field device and such device can be automatically interrogated. Thereafter, the field device can publish certain types of alarms such that software is aware of alarms produced by the controller and alarms/events can be automatically provided to a subscribing entity.

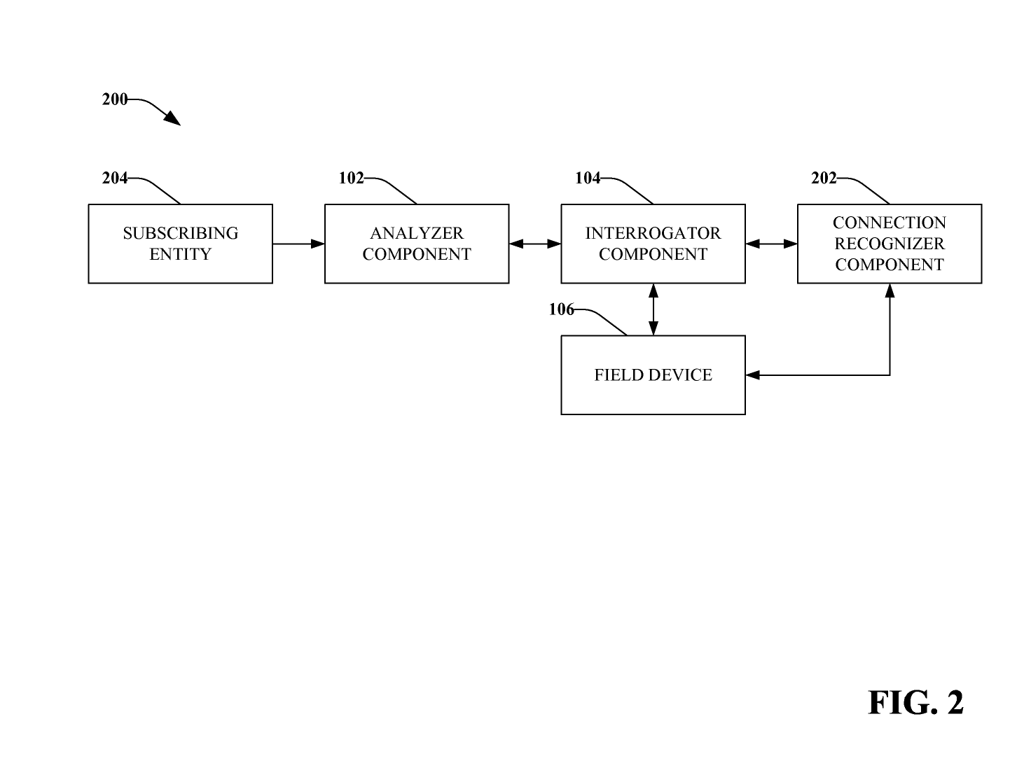

Turning now to FIG. 2, a system 200 that facilitates configuring the field device 106 upon the field device 106 being connected to an industrial automation network is illustrated. The system 200 includes a connection recognizer component 202, which can determine that the field device 106 has been coupled to an industrial communications network for a first time and/or that the field device 106 has been reconfigured. In an example, the field device 106 can be an industrial controller, and can be placed upon a rack (and coupled to a backplane). When the field device 106 is initially placed upon the rack and connected to the backplane, the connection recognizer component 202 can ascertain that the field device 106 has been coupled to the backplane and can communicate such determination to the interrogator component 104. The interrogator component can then be utilized, for instance, to interrogate the field device 106 to determine types of alarms that can be created by the field device 106. The interrogator component 106 can relay such information to the analyzer component 104, which can inform appropriate devices that subscribe to events of the types created by the field device 106.

In an example, a subscribing entity 204 can subscribe to alarms and/or events that are associated with a particular region within an industrial facility (as defined by a known hierarchy). Additionally, the analyzer component 102 can determine that the subscribing entity subscribes to alarms of a type related to the region. When the field device 106 is coupled to the network within the particular area, the connection recognizer component 202 can determine that the field device 106 has been connected. The interrogator component 104 can query the field device 106 to determine types of alarms and/or events the field device 106 is capable of generating, and can communicate with the analyzer component 102 regarding subscriptions associated with the subscribing entity 204. The interrogator component 104 can then configure the field device 106 to publish alarms/events of the particular type such that the subscribing entity 204 will be provided with such alarms/events.

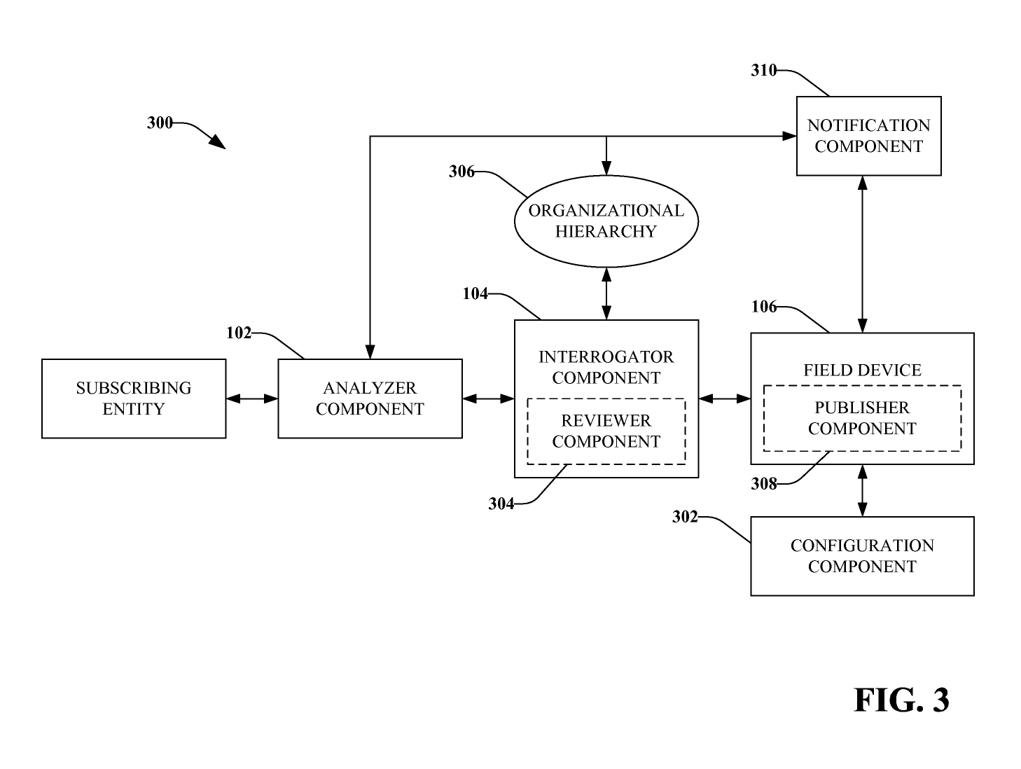

Now referring to FIG. 3, a system 300 that facilitates providing a subscribing entity with alarms/events of particular types is illustrated. Individuals or devices in industrial environments can subscribe to particular alarms and/or events, such that certain alarms/events (associated with particular types and/or identifiers) will be provided to an entity that subscribes to such events. The system 300 includes the analyzer component 102 that can analyze a subscription associated with the subscribing entity, which can subscribe to alarms associated with a certain type or identifier. The analyzer component 102 can determine which type(s) of alarms the subscribing entity subscribes to, and can communicate such information to the interrogator component 104.

The interrogator component 104 is communicatively coupled to the field device 106, which can be configured to generate alarms and/or events. Additionally, the interrogator component 106 can determine types of alarms and/or events that can be created by the field device 106. If the interrogator component 106 determines that the field device 106 creates alarms/events of a type (or subtype) subscribed to by the subscribing entity 204, then a configuration component 302 can automatically configure the field device 106 to provide alarms/events of the desired type to the subscribing entity 204. Thus, when the field device 106 creates an alarm/event of a desired type or subtype, then the field device 106 can publish such event to enable the subscribing entity 204 to access the alarm/event or directly provide the subscribing entity 204 with the alarm/event.

The interrogator component 104 can also include a review component 304, which can review an organization hierarchy 306 associated with an industrial environment and automatically determine other alarms/events related to alarms/events generated by the field device 106. Pursuant to an example, alarms/events created by the field device 106 can be within an organizational hierarchy, and thus be associated with different alarms/events (whether or not such alarms/events are created by the field device 106). More specifically, an alarm generated by the field device 106 may be a parent or child of another alarm, which may be generated by the field device 106 or by another device). Based upon determined relations, the interrogator component 104 can automatically cause the subscribing entity 204 to subscribe to alarms/events related to alarms/events created by the field device 106.

In connection with publishing alarms/events, the field device 106 can include a publisher component 308 that can publish alarms/events such that the subscribing entity 204 can access alarms/events to which the subscribing entity 204 subscribes. The publisher component 308 can be communicatively coupled to a notification component 310, which can provide a notification to the subscribing entity 204 that the field device 106 has published an alarm/event that is desirably received by the subscribing entity 204. The notification component 310 can also review the organizational hierarchy 306 upon receiving a notification of an alarm to determine if the subscribing entity 204 should be notified to search for related alarms (e.g., parent or child alarms).

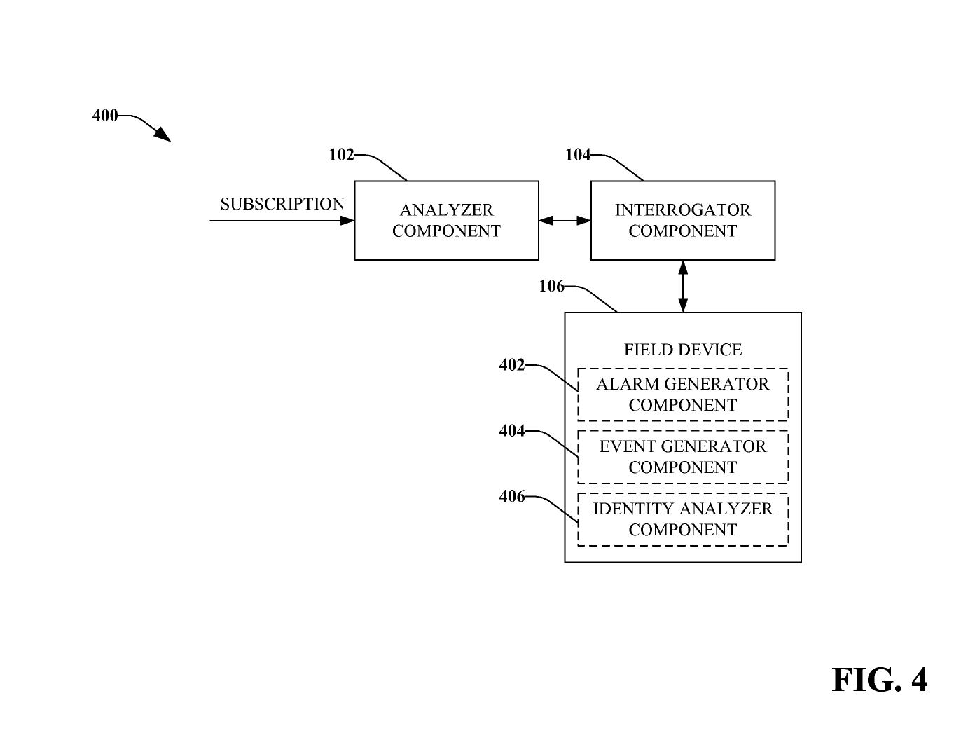

With reference now to FIG. 4, a system 400 that facilitates automatically interrogating a field device for alarms/events is illustrated. The system 400 includes the analyzer component 102, which can analyze a subscription to an alarm/event with respect to a subscribing entity (not shown). For example, the subscribing entity can be another field device, a software program, a human-machine interface (HMI), a web server or other suitable network infrastructure device, and/or the like. Based at least in part upon an analysis of the subscription, the interrogator component 104 can interrogate the field device 106 for alarms/events associated with the subscription. In another example, rather than receiving a subscription, the analyzer component 102 can receive a request to review contents of the field device 106, and the interrogator component 104 can interrogate the field device 106 to illustrate contents thereof (and/or capabilities of the field device 106 with respect to alarms/events) to a user. The user can thereafter select alarms/events to which he/she would like to subscribe.

The field device 106 includes an alarm generator component 402 that enables the field device 106 to create alarms if data produced and/or consumed by such field device 106 lies outside a threshold. For example, if a process variable (representative of a temperature, for instance) lies outside an expected range, then the alarm generator component 402 can generate an alarm indicating as much. Similarly, if certain operator actions are undertaken, such as depression of an emergency stop button, then the alarm generator component 106 can create an alarm with respect to the depression of the button. Moreover, the alarm generator component 106 can create alarms that are instances of a particular type or subtype, can associate an alarm with a unique identifier, and/or can associated a generated alarm with other alarms. For instance, the field device 106 may be within a hierarchy of field devices, and can indicate that an alarm generated by the alarm generator component 402 is a parent or child of an alarm created by another field device. Thus, the alarm generator component 402 can describe any suitable level of relation with respect to alarms created thereby.

The field device 106 can additionally include an event generator component 404 that can create and log events associated with the field device 106. For instance, a time when a batch process is fifty percent completed can be logged as an event. In another example, the event generator component 404 can create and log when an operator signs off on a particular batch. As described above, the analysis 102 and the interrogator component 104 can be utilized to interrogate the field device 106 such that events created and logged therein can be provided to entities that subscribe to such events. More particularly, the event generator component 404 can create events that are instances of particular types and/or subtypes, and a subscribing entity can subscribe to events created by the field device 106 that accord to a particular type (or subtype). Further, the event generator component 404 can create events that are associated with an identifier, and the subscribing entity can subscribe to events that are associated with such identifier.

The field device 106 can additionally include an identity analyzer component 406, which can analyze an identity of a user associated with the field device 106. This identity can then be associated with alarms/events created by the alarm generator component 402 and/or the event generator component 404. Thus, a subscribing entity can subscribe to alarms/events based upon an identity of an operator associated with the field device. Pursuant to an example, a value that identifies the operator can be placed within an alarm/event created by the alarm generator component 402 and/or the event generator component 404. The interrogator component 104 can interrogate the field device 106 for alarms associated with such value, and can cause alarms/events therein to be provided to a subscribing entity and/or configure the field device 106 to provide alarms/events associated with the operator to a subscribing entity.

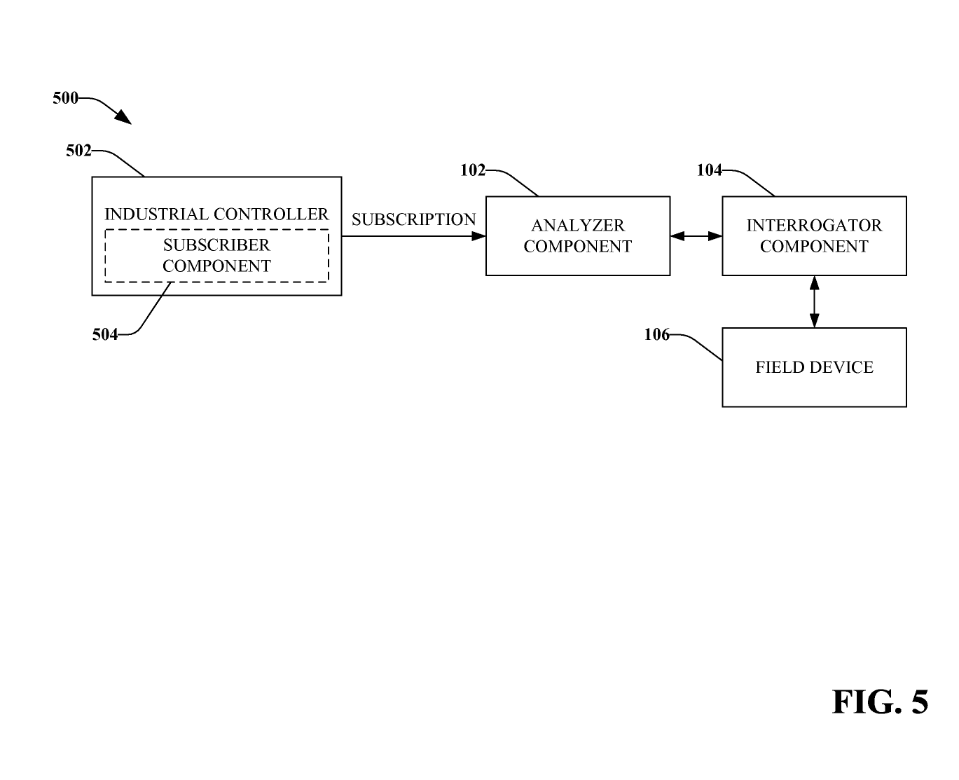

Turning now to FIG. 5, a system 500 that facilitates provision of alarms/events to a subscriber thereto is illustrated. The system 500 includes the analyzer component 102, which receives information relating to a subscription to an alarm/event from an industrial controller 502. The industrial controller 502 can be, for instance, a logic controller, a robotic controller, and/or any other suitable controller. The industrial controller 502 can include a subscriber component 504, which enables the industrial controller 502 to subscribe to alarms/events of a particular type, subtype, associated with a certain operator, associated with a particular identifier, and/or the like. For instance, a user can access the industrial controller 502 and indicate that the controller 502 should subscribe to an event of a particular type related to the field device 106. Additionally or alternatively, an original equipment manufacturer (OEM) can pre-configure the industrial controller 502 to subscribe to alarms/events of a particular type, subtype, etc.

The analyzer component 102 can review a subscription associated with the industrial controller 502 and can relay information relating to the subscription to the interrogator component 104. The interrogator component 104 can analyze contents/capabilities of the field device 106 to determine whether it includes alarms/events desirably received by the industrial controller 502. If the field device 106 includes alarms/events desirably received by the industrial controller 502, the field device 106 can be notified and configured to provide alarms/events of the type, subtype, etc. to the industrial controller 502. Moreover, it is understood that the interrogator component 104 can interrogate a plurality of field devices for alarms/events that may be desirably provided to the industrial controller 502 (or other entities).

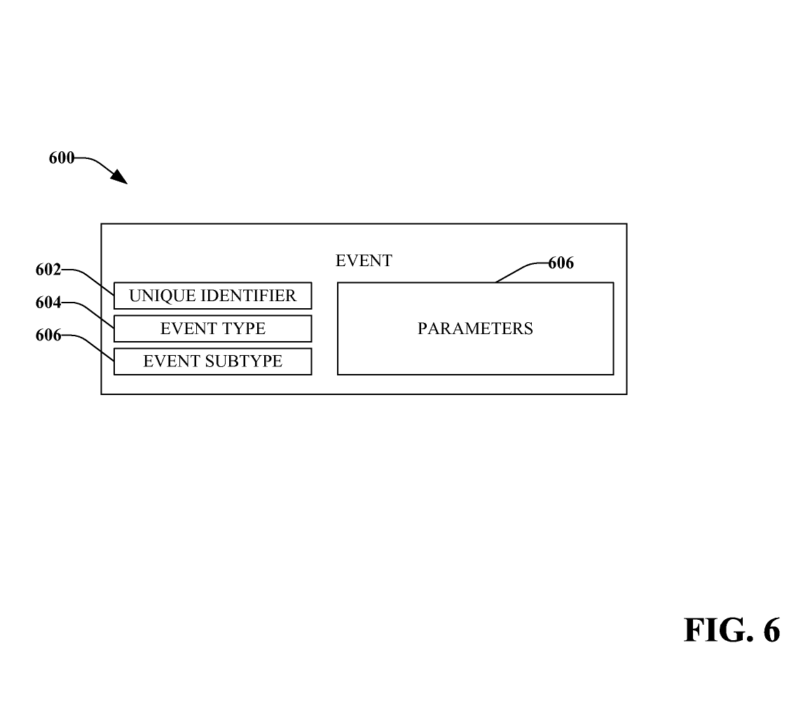

Now referring to FIG. 6, an example event 600 is illustrated, wherein the event can be subject to a subscription with respect to a subscribing entity within an industrial environment. The event 600 includes an identifier 602, which can uniquely identify the event 600 or identify a plurality of related events. For instance, events that are associated with field devices in a same region can be assigned a substantially similar identifier. The event can also include an event type 604 and an event subtype 606. Thus, subscribing entities that subscribe to instances of the event type 604 can receive the event 600. Similarly, subscribing entities that subscribe to instances of the event subtype 606 can receive the event 600. The event 600 can additionally include parameters that describe the event 600. For example, the parameters can include a detailed description of the event, an operator associated with the event, time of occurrence of the event, etc.

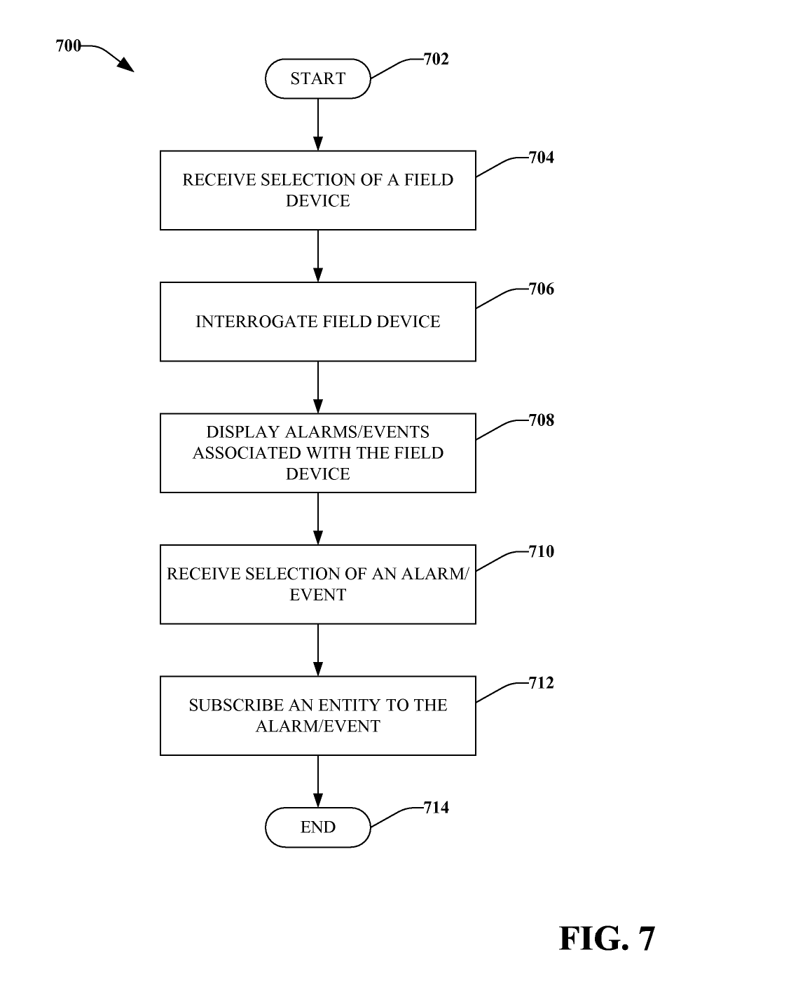

Turning to FIGS. 7-9, methodologies relating to configuring field devices and subscribing to alarms/events are illustrated. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring specifically to FIG. 7, a methodology 700 relating to subscribing to a particular alarm/event is illustrated. The methodology 700 starts at 702, and at 704 a selection of a field device is received. For instance, a graphical user interface can include a plurality of field devices arranged in any suitable manner, such as a hierarchical manner. Through utilization of voice commands, a pointing and clicking mechanism, a pressure sensitive screen, and/or the like the field device can be selected. At 706, the field device is interrogated to determine types and/or subtypes of alarms events stored therein. Additionally, the field device can be interrogated to determine operators associated with the field device, identifiers of alarms/events related to the field device, and/or other suitable information about alarms/events.

At 708, alarms/events associated with the field device are displayed to a user. The display of alarms/events can be arranged by type, subtype, operator, or any other suitable manner. At 710, a selection of a particular alarm and/or event is received. For example, an alarm/event can be selected based upon the type of the event, subtype of the event, association with other alarms/events, etc. At 712, an entity is subscribed to the alarm/event. Pursuant to an example, an alarm/event of a particular type can be selected and type or subtype of the selected alarm/event can be displayed. Thereafter a particular field device can be identified, and the field device can subscribe to alarms/events of the selected type and/or subtype. The methodology 700 then completes at 714.

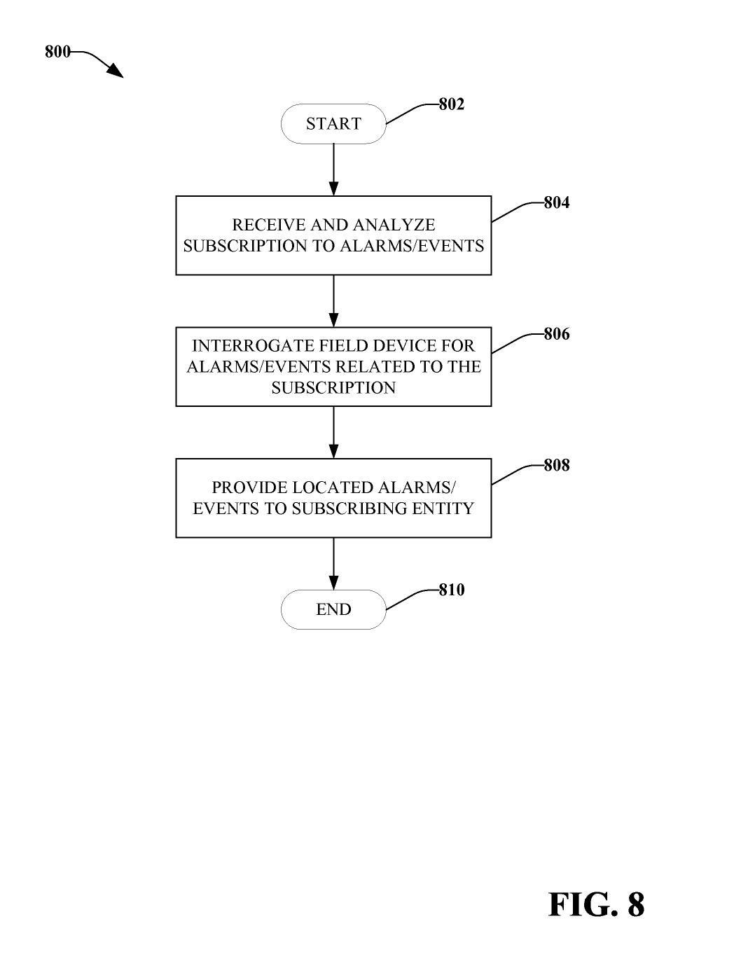

Now turning to FIG. 8, a methodology 800 for performing automatic discovery with respect to alarms/events within an industrial environment is illustrated. The methodology 800 begins at 802, and at 804 a subscription to an alarm/event is received. For instance, the subscription can relate to an alarm/event type, subtype, identifier, operator associated therewith, and/or the like. Additionally, the subscription can be associated with a particular entity, such as an alarm server, a controller or other suitable field device, a network infrastructure device (e.g., a switch, a router, a gateway, . . . ), etc. At 806, a field device is interrogated for alarms/events related to the particular type, subtype, etc. More particularly, the field device can create alarms/events and retain them within a local data store. The field device can then be interrogated to determine type of alarms/events therein and other suitable parameters. Furthermore, the field device can be interrogated to determine capabilities of such device, including capabilities relating to alarm/event generation and retention. For instance, the field device can be interrogated to determine if such field device is capable of creating an alarm/event of a type associated with the subscription. At 808, located alarms/events are provided to the subscribing entity. For example, if the subscription relates to an event of a particular type, and an event of the particular type is located within the field device, then the event is provided to the subscribing entity. The methodology 800 then completes at 810.

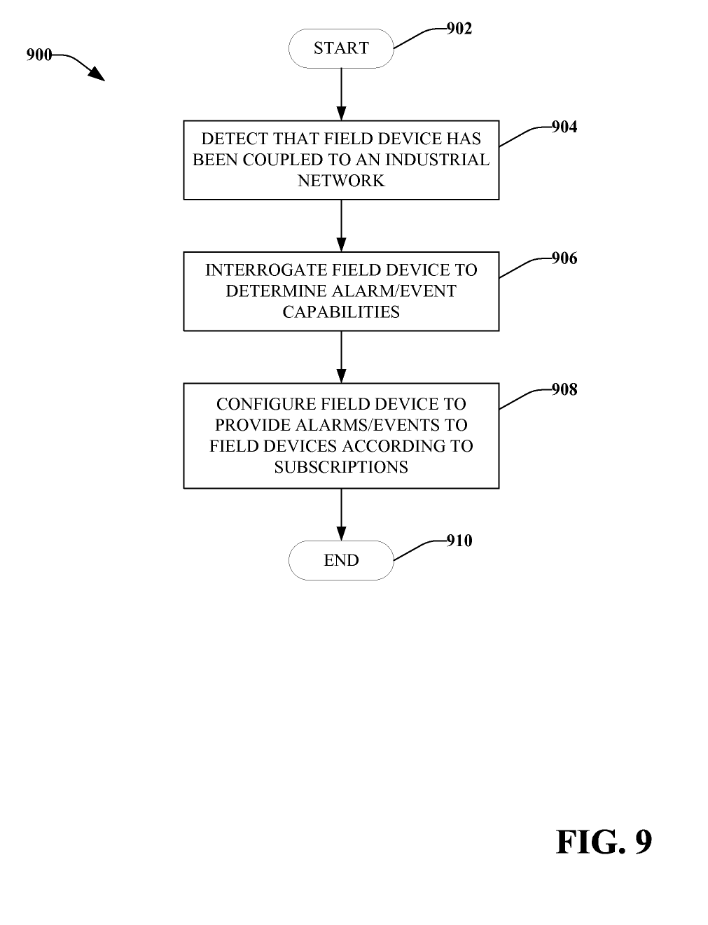

Now referring to FIG. 9, a methodology 900 for automatically configuring a field device, such as an industrial controller, to provide subscribing entities with alarms/events is illustrated. The methodology 900 begins at 902, and at 904 it is detected that a field device has been coupled to an industrial network. More particularly, it can be detected that an industrial controller has been placed upon a rack and coupled to a backplane for a first time. At 906, the field device is interrogated to determine alarm/event generation capabilities. Specifically, types of alarms/events that can be created by the field device can be determined. Moreover, subtypes of alarms/event that may be generated by the field device can be ascertained. The field device can be configured, for instance, by the OEM. At 908, the field device is configured to provide alarms/events of particular types to subscribing entities. For example, devices or operators within an industrial environment may desirably receive alarms/events of certain types, subtypes, etc. The subscriptions can be known prior to interrogating the field device. The methodology 900 then completes at 910.

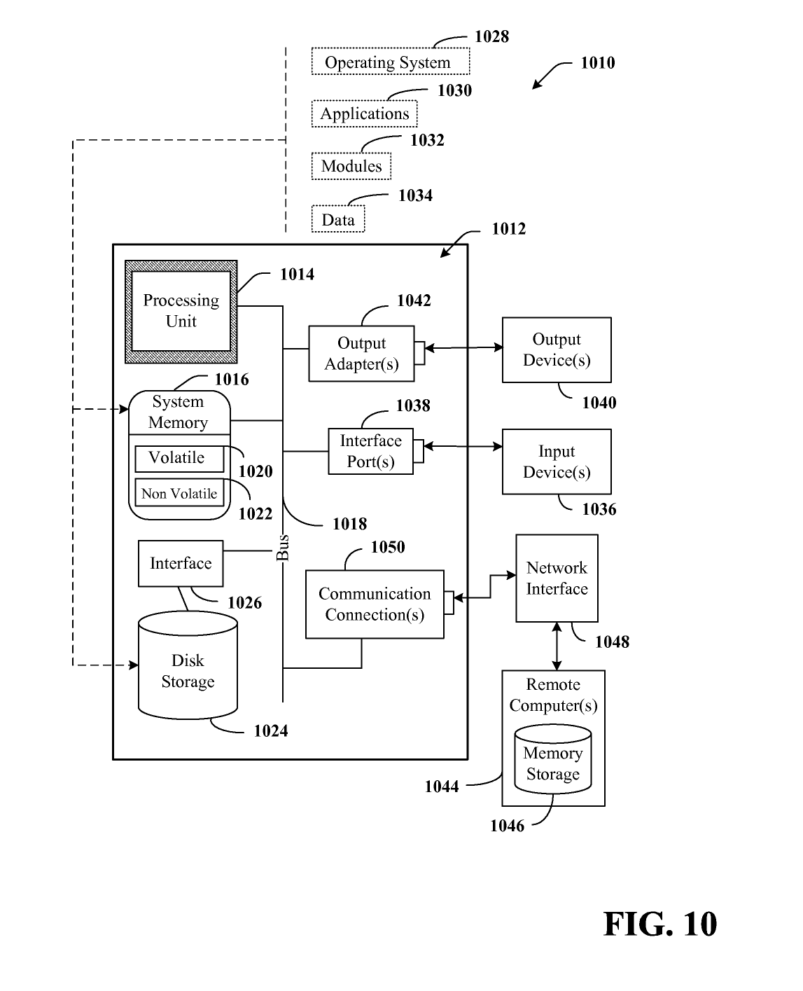

With reference to FIG. 10, an example environment 1010 for implementing various aspects of the aforementioned subject matter, automatically discovering alarms/events, includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable PROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

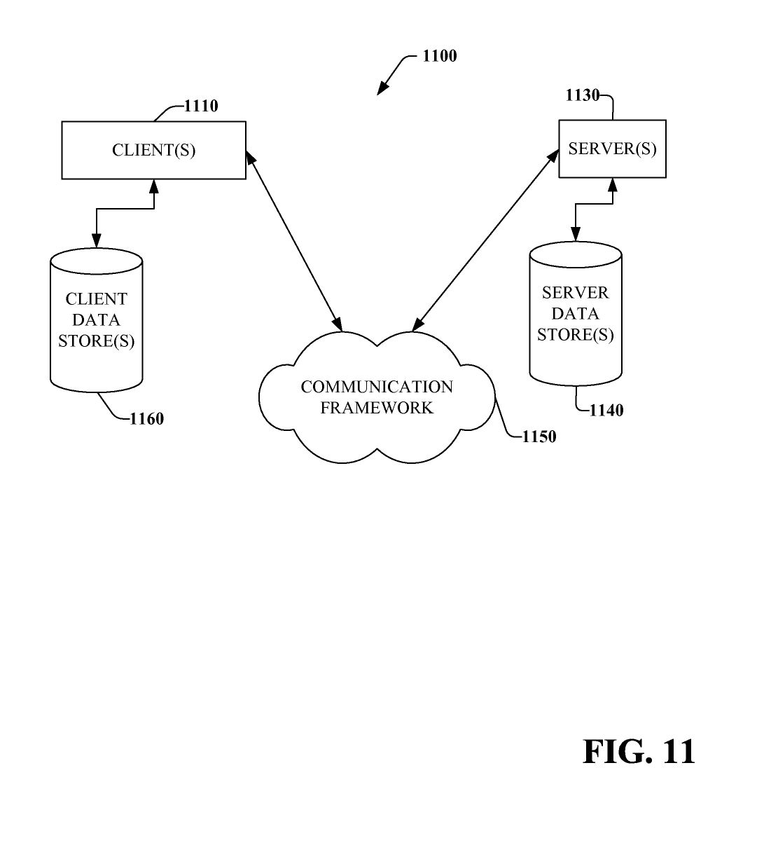

FIG. 11 is a schematic block diagram of a sample-computing environment 1100 with which the disclosed subject matter can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the subject invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates automatic discovery of alarms/events in an industrial environment, comprising:
an analyzer component that receives a subscription to an alarm/event and analyzes the subscription; and
an interrogator component that interrogates a field device to determine whether the field device generates alarms/events that conform to the subscription.

2. The system of claim 1, the subscription includes information relating to an alarm/event type that is desirably received by a subscribing entity.

3. The system of claim 1, the subscription includes information relating to an alarm/event subtype that is desirably received by a subscribing entity.

4. The system of claim 1, the subscription includes information relating to an operator associated with an alarm/event, one or more of an alarm and event associated with the operator is desirably received by the subscribing entity.

5. The system of claim 1, the interrogated field device is an industrial controller.

6. The system of claim 1, further comprising a configuration component that configures the field device with regards to publishing alarms/events to the subscribing entity.

7. The system of claim 1, further comprising a notification component that notifies a subscribing entity that one or more of an alarm and event that accords to the subscription has been published by the field device.

8. The system of claim 7, the notification component analyzes an organizational hierarchy with respect to the industrial environment and notifies the subscribing entity of one or more of alarms and events related to one of an alarm and event subscribed to by the subscribing entity.

9. The system of claim 8, the organization hierarchy is based at least in part upon one or more of ISA S88 and ISA S95.

10. The system of claim 1, the field device comprises a publisher component that publishes alarms and events generated by the field device.

11. The system of claim 1, alarms and events generated by the field device include one or more of an identifier, a type, a subtype, and parameters associated therewith.

12. The system of claim 1, the field device comprises an alarm generator component that creates alarms when a process variable lies outside a threshold.

13. The system of claim 1, the field device comprises an event generator that creates and logs events associated with the field device.

14. A system that facilitates configuring a field device in an industrial environment, comprising:
an interrogator component that determines alarms and events capable of being generated by the field device; and
a configuration component that configures the field device to publish particular alarms and events to a subscribing entity.

15. The system of claim 14, the configuration component configures the field device to publish particular alarms and events to a plurality of subscribing entities.

16. A method for configuring a field device with respect to alarms and events, comprising:
receiving a selection of a representation of the field device on a graphical user interface;
interrogating the field device upon receiving the selection;
displaying alarms and events associated with the field device;
receiving a selection of one or more of an alarm and an event; and
subscribing an entity to the one or more of the alarm and the event such that the field device publishes the one or more of the alarm and the event to the subscribing entity.

17. The method of claim 16, the alarms and events are displayed in a hierarchical manner.

18. The method of claim 16, further comprising displaying one or more of type, subtype, and identifier upon receiving the selection of the one or more of the alarm and the event.

19. A method for automatically discovering alarms and events, comprising:
receiving and analyzing a subscription to one or more of an alarm and an event;
interrogating a field device for alarms and/or events related to the subscription; and
providing located alarms and/or events to a subscribing entity.

20. The method of claim 19, further comprising providing alarms/events related to the located alarms and/or events to the subscribing entity.

21. A system that facilitates automatically discovering alarms and events, comprising:
means for analyzing a subscription to alarms and events with respect to a field device in an industrial environment; and
means for interrogating the field device for alarms and events relating to the subscription.
